(19) United States
(12) Patent Application Publication
(10) Pub. No.: US 2006/0136936 A1
(43) Pub. Date: Jun. 22, 2006

(54) Integrated multipurpose audio-visual optical disk drive

(76) Inventors: Sheng-Fu Lu, Taipei Hsien (TW); Yu-Yuan Lee, Taipei Hsien (TW)

Correspondence Address: TROXELL LAW OFFICE PLLC;Suite 1404, 5205 Leesburg Pike, Falls Church, VA, 22041, US

(21) Appl. No.: 11/018,755

(22) Filed: Dec. 22, 2004

(51) Int. Cl. G11B 33/02; G11B 17/04; G11B 17/03

(52) U.S. Cl. 720/600

(57) ABSTRACT

An integrated multipurpose audio-visual optical disk drive comprises a main machine and a monitor, wherein the main machine comprises a hinge mounted thereon for pivotally connecting the main machine with the monitor so as to enable the monitor to be rotated in various angles. A plurality of control buttons, a plurality of slots, an optical disk receiving opening are formed on a lateral portion and a front surface of the available space of the main machine. The audio-visual optical disk can be carried and used alone by integrating the monitor into the main machine so as to overcome the drawbacks of the conventional structure, which is not workable when the conventional main machine is disassembled. Moreover, every controlling device is mounted on the main machine of the present invention such that the operator is capable of self-controlling and self-adjusting his favorite channels.

### BACKGROUND OF THE INVENTION

1. Field of the Invention

The present invention relates to a flip down type, hang type, and/or sitting type DVD/VCD audio-visual optical disk drive, and more particularly to an audio-visual optical disk drive that overthrows the conventional mounting manner and equips with various functions.

2. Description of the Related Art

The general DVD/VCD audio-visual optical disk drive for car use is directly embedded into the car roof, the driving console, or the car pillow. Therefore, the DVD/VCD audio-visual optical disk drive, which is mounted in accordance with the requirement of the consumer, is immovably mounted thereon no matter where the audio-visual optical disk drive mounts. Moreover, the monitor and the main machine are mounted in different positions and the main machine is always manipulated by the driver or the person who sits beside the driver so as to control the showing of the content. However, the mounting position brings the person who sits behind the driver inconvenience. In addition, if the driver manipulates the audio-visual optical disk drive during driving, the driving safety is threatened significantly.

Furthermore, the DVD/VCD audio-visual optical disk drive that mounts in the immovable manner is usually stolen. In order to diminish the loss, some manufacturers provide a DVD/VCD audio-visual optical disk drive that equips with a demountable and portable main machine. However, the monitor of this kind of DVD/VCD audio-visual optical disk drive is still fixed inside the car even through its main machine is disassembled for reducing the loss. Moreover, the DVD/VCD audio-visual optical disk drive is not workable after the main machine is disassembled and separated from the monitor.

### SUMMARY OF THE INVENTION

In view of the aforementioned circumstance that the conventional car use DVD/VCD audio-visual optical disk drive is designed to be a fixed type structure or only the main machine thereof is demountable to prevent itself from being stolen. Moreover, it distracts the driver from attention since the conventional main machine is identically fixed on the operation region in front of the driver. Therefore, the conventional structure brings about danger. Accordingly, the present inventors energetically try to improve the car use DVD/VCD audio-visual optical disk drive so as to promote its application scope and practicability.

The primary object of the present invention is to provide a DVD/VCD audio-visual optical disk drive in which the main machine and the monitor are integrated into a unity. This DVD/VCD audio-visual optical disk drive is primarily suitable for the car or portable for use in any place. The main machine is particularly integrated with the monitor so as to make the operation and the use of the present invention more convenient. Moreover, the operator is capable of self-controlling his favorite channels and there is no need to ask somebody to perform the control operation for him.

Another object of the present invention is to provide a portable DVD/VCD audio-visual optical disk drive, wherein the integrated structure of the main machine and the monitor makes the DVD/VCD audio-visual optical disk drive suitable for any place. When the present invention is disassembled from the car, the present invention is still workable. However, in the convention structure, only the main machine can be disassembled from the car and the portable main machine is not workable.

The other features and preferred embodiments of the present invention will now be described with reference to the accompanying drawings.

### BRIEF DESCRIPTION OF THE DRAWINGS

FIG. 1 is an elevational view showing the outward appearance of the present invention.

FIG. 2 is an elevational view showing the buckling status between the monitor and the main machine of the present invention.

FIG. 3 is an elevational view showing the buckling structures of the monitor and the main machine of the present invention.

FIG. 4 is a schematic view showing the practice status of the present invention, wherein the audio-visual optical disk drive is mounted on the desk's surface or inside the car.

FIG. 5 is a schematic view showing the practice status of the present invention, wherein the present invention is mounted on the wall or the car pillow.

FIG. 6 is a schematic view showing the practice status of the present invention, wherein the audio-visual optical disk drive is mounted on the car roof.

### DETAILED DESCRIPTION OF THE PREFERRED EMBODIMENT

The present invention will become apparent from the following detailed description of the preferred embodiments with reference to the accompanying drawings.

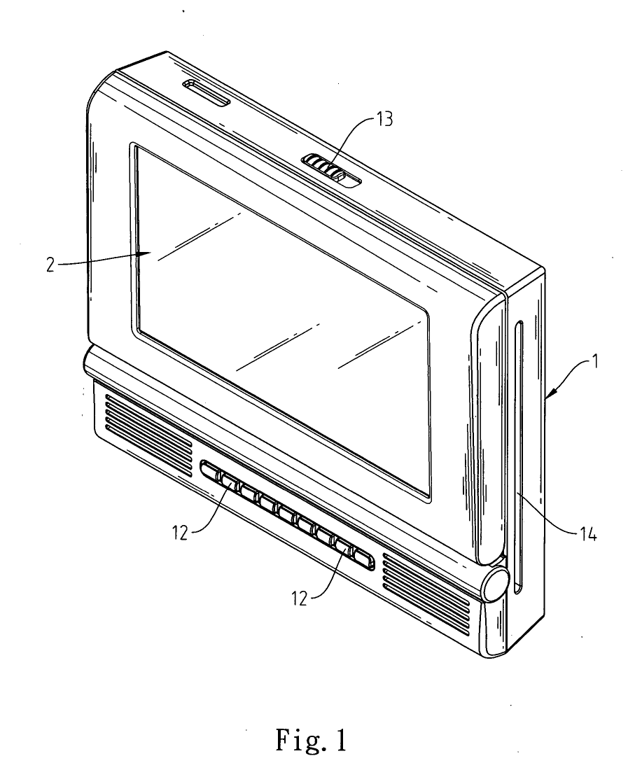

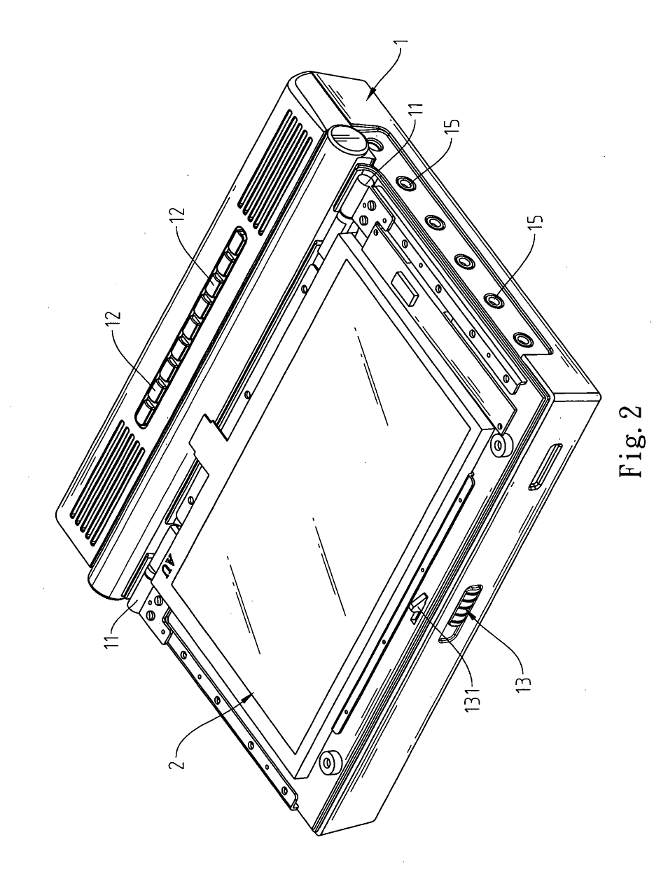

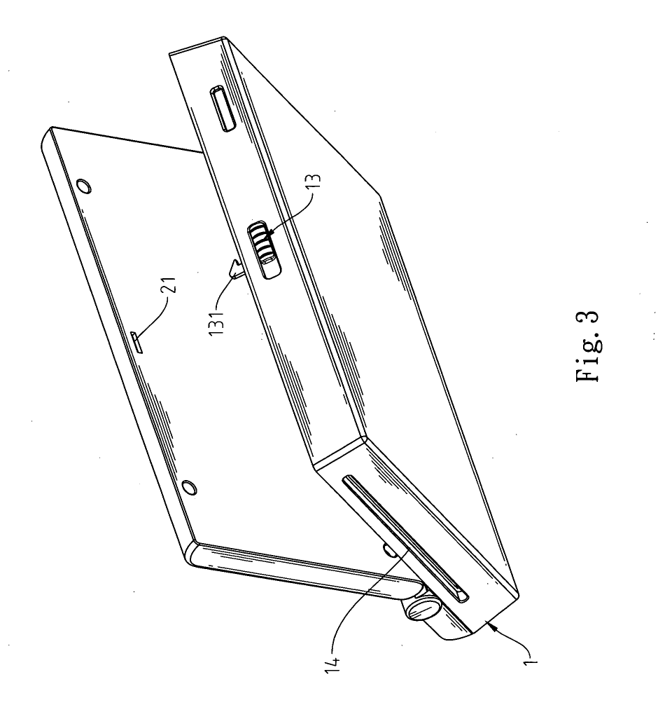

As shown in FIG. 1 through FIG. 3, an integrated multipurpose audio-visual optical disk drive primarily comprises a main machine 1 and a monitor 2, wherein a hinge 11 is mounted on the main machine 1 for pivotally connecting the main machine 1 with the monitor 2 so as to enable the monitor 2 to be rotated in various angles.

The monitor 2 is mounted on the front surface of the main machine 1 and the main machine 1 described above is further an audio-visual optical disk drive for showing the DVD and VCD, wherein several control buttons 12, slots 15, and an optical disk receiving opening 14 are formed on the lateral portion or other preferred mounting positions of the available space of the main machine 1. The control buttons 12 provide the functions of selection for showing the DVD and/or VCD films, adjusting volume, tuning channels, etc. The slots 15 provide the functions of connecting with an external power source, transmitting data, downloading data, etc. The optical disk receiving opening 14 is formed to receive a film disk for showing thereof.

For the purpose of seeing, the monitor 2 that pivotally mounts on the main machine 1 can be adjusted. Moreover, the monitor 2 further comprises a clasp-receiving trench 21 mounted on the bottom fringe of the monitor 2. A clasp 131 is mounted on the main machine 1 in a position corresponding to the clasp-receiving trench 21, wherein the clasp 131 is controlled by a shift-button 13. If it is desired to fold up the monitor 2 and the main machine 1, the clasp 13 1 controlled by the shift-button 13 buckles the clasp-receiving trench 21 so as to orientate the monitor 2.

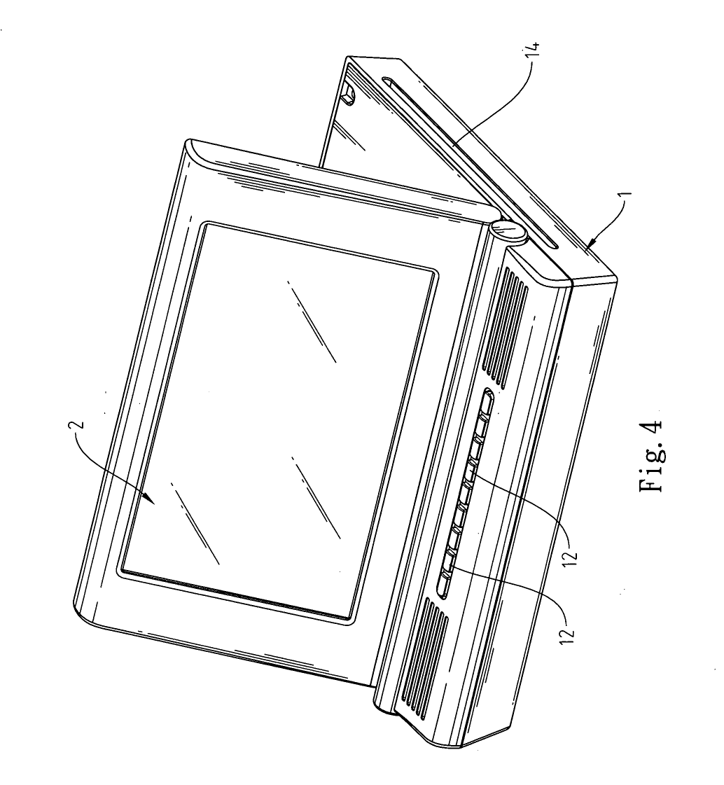

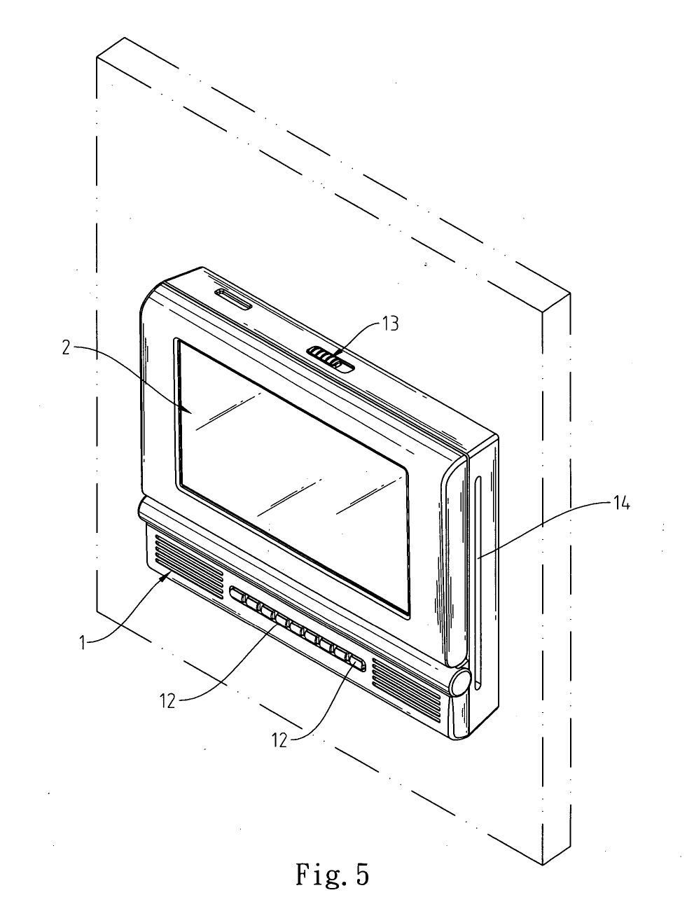

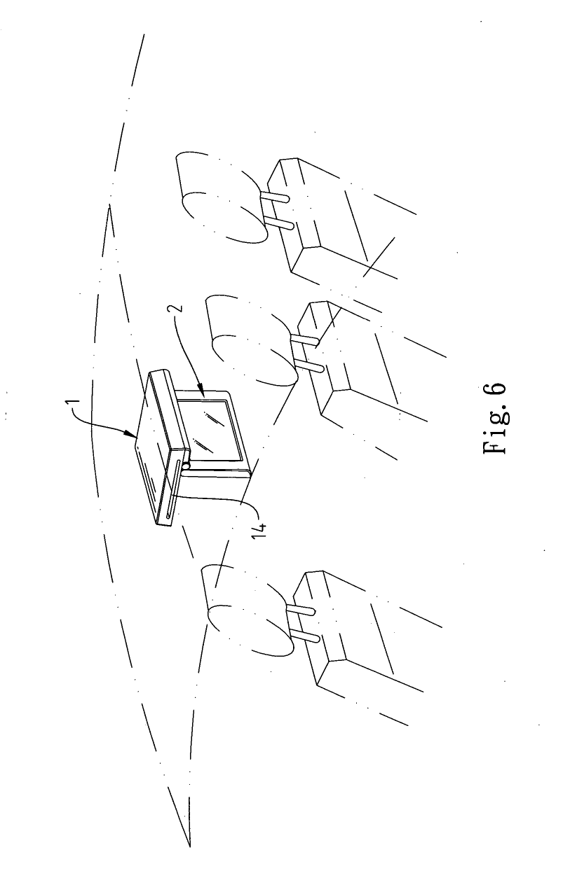

Please refer to FIG. 4 through FIG. 6, which show that the audio-visual optical disk drive is mounted respectively on the front panel, console's surface, car pillow, and car roof inside the car, wherein the audio-visual optical disk drive may be mounted on the front panel and other aforementioned positions inside the car as the general fixed type monitor. Since the present invention discloses a DVD/VCD audio-visual optical disk drive that integrates the main machine 1 with the monitor 2, the operation of this DVD/VCD audio-visual optical disk drive becomes more convenient and the operator is capable of controlling his favorite channels by himself. Accordingly, it provides the operator with convenience in use and there is no need to ask somebody to perform the control operation for him.

Moreover, since the audio-visual optical disk drive of the present invention is composed of integrated main machine 1 and monitor 2, the present invention is more valuable than the conventional separate type audio-visual optical disk drive, which is not workable when the conventional main machine is disassembled. Furthermore, the audio-visual optical disk drive of the present invention can be independently carried and applied to any place.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An integrated multipurpose audio-visual optical disk drive comprising: a main machine and a monitor, wherein the main machine comprises a hinge mounted thereon for pivotally connecting the main machine with the monitor so as to enable the monitor to be rotated in various angles, wherein the improvement comprises:
a plurality of control buttons, a plurality of slots, and an optical disk receiving opening formed on a lateral portion and a front surface of the available space of the main machine;
a clasp-receiving trench mounted on a bottom fringe of the monitor; and
a clasp mounted on the main machine in a position corresponding to the clasp-receiving trench, wherein a shift-button controls the clasp and the clasp controlled by the shift-button buckles the clasp-receiving trench so as to orientate the monitor, wherein the integrated multipurpose audio-visual optical disk can be carried and applied alone by integrating the monitor into the main machine, and every controlling device described above is mounted on the main machine such that the operator is capable of self-performing the control and adjustment operations.
